(19) United States
(12) Patent Application Publication
(10) Pub. No.: US 2014/0057222 A1
(43) Pub. Date: Feb. 27, 2014

(54) ORTHODONTIC BITE JUMPING DEVICE

(71) Applicant: SWADESH KUMAR, KONGSVINGER (NO)

(72) Inventor: SWADESH KUMAR, KONGSVINGER (NO)

(21) Appl. No.: 13/951,544

(22) Filed: Jul. 26, 2013

(30) Foreign Application Priority Data
Aug. 27, 2012 (IN) 2478/MUM/2012

(51) Int. Cl. A61C 7/36; A61C 7/20

(52) U.S. Cl. CPC A61C 7/36; A61C 7/20
USPC 433/19

(57) ABSTRACT

The present invention relates particularly to an orthodontic device attached to orthodontic brace wires connected to teeth of the upper and lower jaw for treatment of Class II malocclusions. The orthodontic bite jumping device is attached to a pair of orthodontic brace wires affixed to a patient's teeth for correcting a relative position of dental arches. The device comprises one tubular member having an eyelet at one end for connection to a first brace wire and a tube stop at another end and one plunger member slidably and concentrically disposed in the tubular member. The plunger member includes an eyelet at one end for connection to a second brace wire and a plunger stop, such that the plunger stop when coupled with the tube stop is adapted to prevent disengagement of the plunger member from the tubular member when mouth of the patient is opened to a maximum position.

### FIELD OF THE INVENTION

The present invention relates to orthodontic bite jumping devices and, more particularly to an orthodontic device which is attached to orthodontic brace wires connected to teeth of the upper and lower jaw for treatment of Class II malocclusions.

### BACKGROUND OF THE INVENTION

Orthodontics is the study of dentistry that is concerned with the treatment of improper bites, and crooked teeth. It involves purposefully moving teeth towards a certain predefined pattern so that the tooth row has an aesthetically pleasing look. The condition of crowded or crooked teeth is called malocclusion. A variety of malocclusions have been corrected with conventionally available orthodontic appliances for achieving realignments of the teeth so that an appropriate alignment is established for the upper teeth, for the lower teeth, and between the upper and lower jaws. Orthodontic treatment focuses on dental displacement only and deals with the control and modification of facial growth. Commonly metal wires (often called brace wires or arch wires) are inserted into orthodontic brackets (dental braces), which can be made from stainless steel or a more aesthetic ceramic material. The wires interact with the brackets to move teeth into the desired positions. Additional components including removable appliances like plates, headgear, expansion appliances, are also used to move teeth and jaw bones.

An orthopaedic appliance for correcting Class II malocclusion (also referred as orthodontic bite jumping device) operates by forcing the lower jaw forward when the mouth is closed. In adult and growing patients, this produces permanent muscle changes of the lower jaw and its joint, bone modelling and remodelling and permanent correction to a normal Class I bite. Early efforts involved the application of orthodontic appliances to the teeth in conjunction with elastic rubber bands to apply appropriate forces to the orthodontic appliance which is transferred to the teeth, as well as removable head gear for interacting with the teeth, to achieve desired movements. Although these techniques have provided satisfactory results, they were found to be subject to certain disadvantages.

An early bite jumping device was the Herbst appliance, which is disclosed in German Patent No. DE374163. A metal band of the Herbst appliance was placed around an upper molar and lower bicuspid. These two bands were interconnected by a telescopic device to exert an anteriorly directed force on the lower jaw, which eventually brings the lower jaw into alignment with the upper jaw. As an orthodontic patient closes his or her teeth, the telescoping member slides until a predetermined limit is reached. Beyond that limit, the telescoping segments exert a force that tends to reposition the mandible forward with respect to the maxilla, and thereby over the duration of treatment, physiological accommodation and a correction of the over-bite condition is achieved.

The Herbst appliance, however, inhibited lateral movement of the jaw and it needed great strength to resist breakage from lateral jaw forces, therefore it was bulky and interfered with speaking, eating and other oral activities. It also comprises of two units, where the rod and tubes portion are to be adjusted by cutting with diamond disc to the desired length suitable for the orthodontic patient. The Herbst appliance has to be manufactured by a dental technician in the lab and it cannot be attached to the fixed appliance (Braces). This adds to the cost. This involves time and also, due to short length of the tube the rod may extend beyond the tube at the distal end thus causing soft tissue irritation. In other group of patients rod may disengage from the tube when the mouth is opened wide, which can be cumbersome for the patients with extra visit to the dental office to fix the length of the rod.

Considering the drawbacks of the Herbst appliances several attempts were made to overcome these drawbacks and improve the appliance over a period of time. For example U.S. Pat. No. 6,361,315 disclose an orthodontic appliance and kit adapted to provide Herbst therapy as well as arch development. The appliance includes mandibular and maxillary components to be attached to the teeth, each component having a threaded bore. For Herbst therapy, telescoping links are connected between the components with screws threadably received by the threaded bores and coupled to the links by a ball and socket joint. For arch development, expansion mechanisms are provided on the components.

U.S. Pat. No. 6,547,560 discloses an orthodontic bite jumping device for use in the treatment of malocclusion or overbite, having a telescoping limiting assembly to prevent an inner cylindrical member from being completely pulled-out of an outer tube as a patient opens their mouth very wide. The outer tube is adapted to be mounted to an upper jaw or maxilla and the inner cylindrical member is concentrically disposed in the outer tube and adapted to be mounted to a lower jaw or mandible. The telescoping limiting assembly limits the distance the inner cylindrical member can slide out of the outer tube via a pair of notches and an L-shaped resilient lever arm. The first notch is formed in close proximity to a free end of the outer tube. The second notch is formed in close proximity to a free end of the inner cylindrical member and has a rear blocking surface and a forward descending slope or ramped surface to a bottom of the rear blocking surface. In operation, the L-shaped resilient lever arm tracks the forward descending slope or ramped surface in and out of the second notch.

U.S. Pat. No. 6,669,474 discloses an orthodontic interarch device includes a recurve bend located adjacent a shepherd's hook or loop-type attachment that makes the anterior end of the device rotate downwardly rather than upwardly when force is applied. As the person's jaws move, a cam action against the archwire is produced that does not allow the hook or loop attachment end of the device to move above the horizontal plane of the bite as the connection rotates. The recurve bend should be a minimum of 120 degrees from the longitudinal axis of the interarch device in the backward direction. As the degree of this backward curvature approaches 210 degrees, the recurve bend further positions a hook attachment pivot point below axis of the body of the interarch device in the vertical plane. This further prevents the appliance from rotating into the bite.

Similarly U.S. Pat. No. 4,462,800 discloses an orthodontic bite jumping device for attachment to orthodontic brace wires affixed to the teeth of the upper and lower jaw of a patient for treatment of overbite. The device includes, for each side of the jaw, a telescope mechanism which is mounted at either end on a respective trunnion member affixed to a brace wire located on the upper and lower teeth. Each trunnion member has a radial slot adjacent the inner end for receiving one of the brace wires. The connection between at least one of the ends of the telescope mechanism and the respective trunnion is such as to provide looseness or “play” in the interaction thereof, making the device more flexible and resilient and thus more durable within the mouth, while at the same time maximizing the comfort of the patient.

Most of the telescopic orthodontic devices described above and available in the market comprise of two or more telescopic tubes, which makes the device more bulky and fragile due to more than one tube. In order to keep the size of the telescopic unit to a minimum, the metal is too thin in the secondary tubes to bear the masticatory forces of muscle of mastication, which makes them easily deform under normal operating condition and also in abnormal condition for example person actively involved in gymnastic or sport activities.

The available orthodontic device using telescopic assembly of a tube and rod pose a problem that rod/tube disengages when the patient opens mouth very wide. If the rod disengages from the tube when the patient yawns or opens their mouth wide, the purpose of the orthodontic treatment is defeated. The assembly may also disengage inadvertently and it is frustrating for the patient to again engage it. One more problem with these devices is that during the course of treatment the maximum and minimum opening lengths of the orthodontic device has to be varied depending on the achieved relative position of the dental arches. The technician installing the appliance has to spend time measuring and then cutting the rods and tubes to fit the variations in the installation.

Also due to breakage of the lower arch Herbst device or similar devices need special type of hardware, for example stiff crown and bar with soldered pivots to attach such devices to correct the bite. This requires lab and extra expenses thus rules out wide scale integration with the standard orthodontic appliances available in most of the clinics. In most of the devices in the market, the lower rod of the telescopic assembly is manufactured as one unit with a lower eyelet, having fixed length. Also they are too bulky, fragile and cannot be easily adjusted to different mouth opening sizes of the orthodontic patients.

In view of the disadvantages inherent in the available orthodontic bite jumping devices, there exists need for an improved orthodontic device capable of overcoming disadvantages inherent in conventional orthodontic bite jumping devices in a fast, robust, cost effective, secure, and environmental friendly manner.

### SUMMARY OF THE INVENTION

In view of the foregoing disadvantages inherent in the prior arts, the general purpose of the present invention is to provide an improved combination of convenience and utility, to include the advantages of the prior art, and to overcome the drawbacks inherent therein.

In one aspect, the present invention provides an orthodontic bite jumping device attached to a pair of orthodontic brace wires affixed to a patient's teeth for correcting a relative position of dental arches. The device comprises one tubular member having an eyelet at one end for connection to a first brace wire and a tube stop at another end and one plunger member slidably and concentrically disposed in the tubular member. The plunger member is having an eyelet at one end for connection to a second brace wire and a plunger stop, such that the plunger stop when coupled with the tube stop is adapted to prevent disengagement of the plunger member from the tubular member when mouth of the patient is opened to a maximum position.

In another aspect, the present invention provides a orthodontic bite jumping device such that the plunger member comprises one rod which is removably and threadably attached to the eyelet, so a desired length of the orthodontic bite jumping device is obtained by attaching the rod of required length to the eyelet.

In another aspect, the present invention provides a orthodontic bite jumping device, where the plunger stop is made of an enlarged end portion having a diameter more than the diameter of the plunger member and the tube stop comprises an end recess portion having a diameter less than the inner diameter of the tubular member, such that the end recess portion of the tubular member receives the enlarged end portion of the plunger member and prevents disengagement.

In yet another aspect, the present invention provides an orthodontic bite jumping device further comprises one spring for providing a resilient force between the two ends of the orthodontic bite jumping device.

According to another aspect, the present invention provides an orthodontic bite jumping device where the tubular member and the plunger member are attached to the pair of brace wires from the respective eyelets using one mechanism from a pivot, a screwed pivot, a soldered pivot or a combination thereof.

These together with other objects of the invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

The advantages and features of the present invention will become better understood with reference to the following more detailed description taken in conjunction with the accompanying drawings in which:

FIG. 1 illustrates an orthodontic bite jumping device connected between the patient's upper and lower teeth, according to one embodiment of the present invention;

FIG. 2 illustrates an exploded view of the orthodontic bite jumping device, according to one embodiment of the present invention;

FIG. 3 illustrates the tubular member and plunger member assembled in one operating position, according to one embodiment of the present invention;

FIG. 4 illustrates the orthodontic bite jumping device with spring, according to another embodiment of the present invention;

FIG. 5 illustrates the side view of the orthodontic bite jumping device installed in the head gear tube from the mesial end, according to one embodiment of the present invention;

FIG. 6 illustrates the side view of the orthodontic bite jumping device installed in the head gear tube from the distal end, according to one embodiment of the present invention;

FIG. 7 illustrates the perspective partial cross sectional view of the orthodontic bite jumping device with bent rod, according to another embodiment of the present invention;

FIG. 8 illustrates side view of the orthodontic bite jumping device as shown in the embodiment of FIG. 7, installed in a patient's mouth;

FIG. 9 illustrates a schematic diagram of a method of reinforcement of the lower arch using a plurality of wires; more than one wire;

FIG. 10 illustrates a schematic diagram a method of reinforcement of the lower arch using a tube and a large size bonding base with a open tube;

FIG. 11 illustrates the orthodontic bite jumping device according to the present invention installed on the reinforcement of the lower arch as shown in FIG. 10 in a patient's mouth;

FIG. 12 illustrates a occlusal view of the lower arch of a patient's mouth with the orthodontic bite jumping device according to the present invention installed on the posterior sectional arches; and

FIG. 13 illustrates a posterior side view of the lower arch of a patient's mouth with the orthodontic bite jumping device according to the present invention installed on the posterior sectional arches.

Like reference numerals refer to like parts throughout the several views of the drawings.

### DETAILED DESCRIPTION OF THE DRAWINGS

The exemplary embodiments described herein detail for illustrative purposes are subject to many variations and structure and design. It should be emphasized, however that the present invention is not limited to particular orthodontic device attached to orthodontic brace wires connected to teeth of the upper and lower jaw for treatment of Class II malocclusions as shown and described. Rather, the principles of the present invention can be used with a variety of configurations and structural arrangements of orthodontic devices. It is understood that various omissions, substitutions of equivalents are contemplated as circumstances may suggest or render expedient, but the present invention is intended to cover the application or implementation without departing from the spirit or scope of the it's claims.

In the following description, for purposes of explanation, numerous specific details are set forth in order to provide a thorough understanding of the present invention. It will be apparent, however, to one skilled in the art that the present invention may be practiced without these specific details.

As used herein, the term ‘plurality’ refers to the presence of more than one of the referenced item and the terms ‘a’, ‘an’, and ‘at least’ do not denote a limitation of quantity, but rather denote the presence of at least one of the referenced item. The term ‘device’ also includes ‘engine’ or ‘machine’ or ‘system’ or ‘apparatus’.

The terms ‘upper arch’ or ‘upper teeth’ or ‘upper jaw’ or ‘upper dental arch’ or ‘maxilla’ or ‘maxillary arch’ may be used herein interchangeably and refer to convey the same meaning. Similarly ‘lower arch’ or ‘lower teeth’ ‘lower jaw’ or ‘lower dental arch’ or ‘mandible’ or ‘mandibular arch’ may be used herein interchangeably and refer to convey the same meaning.

In an exemplary embodiment, the present invention provides improved orthodontic bite jumping device. The device of the present invention may be mass produced inexpensively and provides user an easy, robust, efficient, secure, cost effective, environment friendly and productive way.

It is to be understood that the improvements of the present invention are applicable to any of a number of orthodontic procedures other than those which are specifically described below. Such orthodontic procedures will be readily understood by the person of ordinary skill in the art, and are achievable by causing the various elements of the orthodontic bite jumping device to interact with the teeth, and if desired, the jaws employing techniques that are themselves known in state of the art.

Orthodontic treatment involves movement of malpositioned teeth to orthodontically correct positions. During treatment, tiny orthodontic appliances known as brackets are often connected to anterior, cuspid and bicuspid teeth, and an archwire is placed in a slot of each bracket. The archwire forms a track to guide movement of the brackets and the associated teeth to desired positions for correct occlusion. Typically, the ends of the archwire are held by appliances known as buccal tubes that are secured to the patient's molar teeth. The brackets, archwires and buccal tubes are commonly referred to as “braces”.

The orthodontic treatment of some patients includes correction of the alignment of the upper dental arch with the lower dental arch. For example, certain patients have a condition referred to as a Class II malocclusion where the lower dental arch is located an excessive distance in a rearwardly direction relative to the location of the upper dental arch when the jaws are closed. Other patients may have an opposite condition referred to as a Class III malocclusion wherein the lower dental arch is located in a forwardly direction of its desired location relative to the position of the upper dental arch when the jaws are closed.

Orthodontic treatment of Class II and Class III malocclusions are commonly corrected by movement of the upper dental arch as a single unit relative to movement of the lower dental arch as a single unit. Force may be applied to each dental arch as a unit by applying force to the brackets or buccal tubes, the archwires, or attachments connected to the brackets, buccal tubes, or archwires. In this manner, a Class II or Class III malocclusion can be corrected at the same time that the archwires and the brackets are used to move individual teeth to desired positions relative to each other.

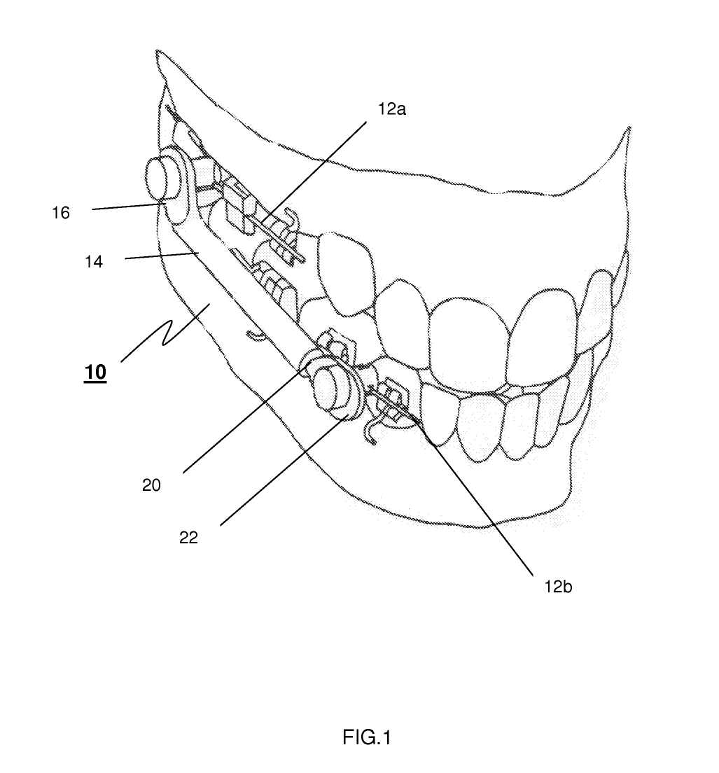

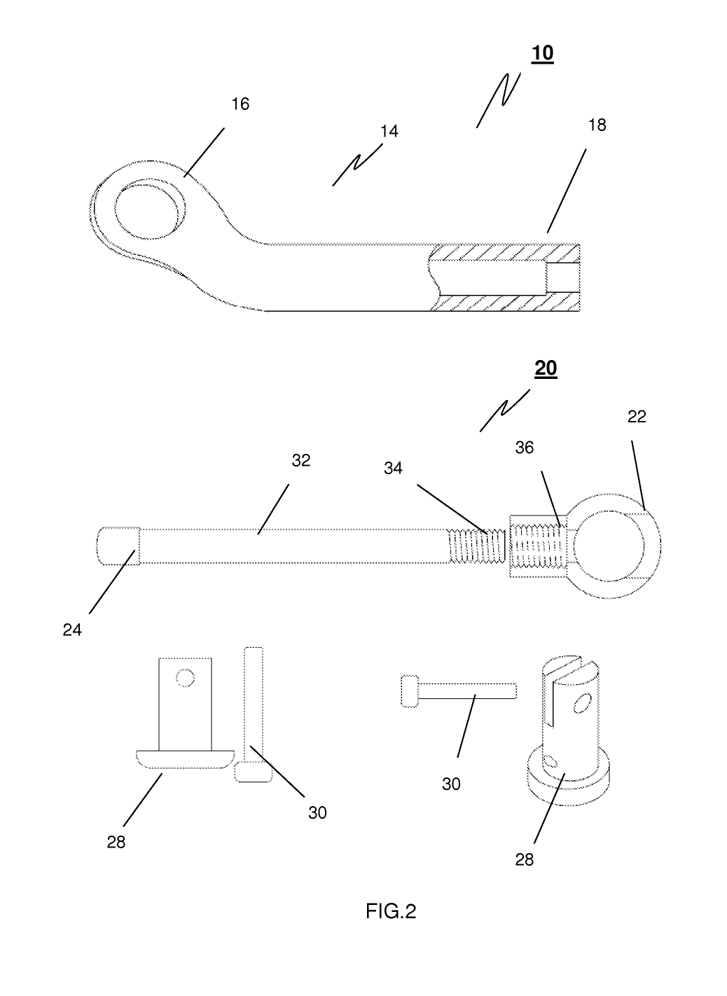

Referring to FIGS. 1 and 2 which illustrates an orthodontic bite jumping device 10 according to one embodiment of the present invention. The orthodontic bite jumping device 10 is attached to a pair of orthodontic brace wires 12 affixed to a patient's teeth for correcting the relative position of the dental arches. The orthodontic bite jumping device 10 comprises one tubular member 14 having an eyelet 16 at one end from which it is connected to a first brace wire 12a and a tube stop 18 at another end, and one plunger member 20 slidably and concentrically disposed in the tubular member 14. The plunger member 20 has an eyelet 22 at one end for connection to a second brace wire 12b and a plunger stop 24, such that the plunger stop 24 when coupled with the tube stop 18 is adapted to prevent disengagement of the plunger member 20 from the tubular member 14 when mouth of the patient is opened to a maximum position.

The tubular member 14 and the plunger member 20 form a telescopic mechanism and the plunger member 20 slides into the tubular member 14. They form a cylinder piston type of assembly with tubular member acting as a cylinder and the plunger member as a piston. The plunger member is freely slidable relative to the tubular member. The eyelet 16 of the tubular member is angularly offset from the longitudinal axis of the tubular member 14. In a preferred embodiment of the present invention the eyelet 16 of the tubular member is angularly offset by 45 degrees towards the teeth. The tubular member 14 may be manufactured as a single part. In another embodiment the tubular member 14 may be manufactured as plurality of parts. The plurality of parts may be two or more tubular members combined into a single tubular member and may slide into each other as a telescopic mechanism.

The tubular member 14 and the plunger member 20 are generally cylindrical in shape and have longitudinal axes which are adapted to be aligned when the plunger member 20 is concentric with the tubular member 14. It is to be understood that the tubular member 14 and the plunger member 20 may be manufactured in any other cross sectional shape for example square, hexagonal or other cross sections without deviating from the principle of telescopic members of a telescopic assembly.

The orthodontic bite jumping device 10 may be mounted in a patient's mouth by securing the device 10 from the eyelet 16 of the tubular member and eyelet 22 of the plunger member to the brace wires 12a and 12b respectively using a pair of pivot 28 and pin 30 assembly. The pivot passes through the eyelets 16 and 22 and includes a hole to receive the brace wires 12 to pass through it and pin 30 is inserted in another hole to keep the pivot in position and the orthodontic device 10 installed on the brace wires 12 without disengaging. The pivot 28 and pin 30 may be made of stainless steel, brass or any metal or plastic or ceramic to suit the needs. In the embodiment shown in FIG. 1 the brace wire 12a is secured on the maxilla and 12b on the mandibula of the patient.

In another embodiment the orthodontic bite jumping device may be mounted in a reverse manner by securing the device 10 from the eyelet 16 of the tubular member to brace wire 12b and eyelet 22 of the plunger member to the brace wire 12a. By mounting the orthodontic bite jumping device 10 in reverse manner a reverse force is obtained which may be used to correct Class III malocclusion.

In another embodiment of the present invention the orthodontic bite jumping device may be secured to the brace wires 12a and 12b from the eyelets 16 and 22 by using any one mechanism from a list of a pivot, a screwed pivot, a soldered pivot or a trunnion and threaded screw assembly or the pivot with thread at one end to receive a screw and a rectangular hole at the other end to receive wire, as described in U.S. Pat. No. 5,183,388 issued to Swadesh Kumar, entitled “MOBILE HINGE MEMBER AND ORTHODONTIC APPLIANCE USING IT” or a combination thereof. The document U.S. Pat. No. 5,183,388 is hereby included by reference and hereafter ‘pivot and screw of U.S. Pat. No. 5,183,388’ references to the “mobile hinge member” as described in U.S. Pat. No. 5,183,388.

The plunger member 20 comprises one rod 32 and eyelet 22. The rod 32 is removably attached to the eyelet 22, such that a desired length of the orthodontic bite jumping device is obtained by attaching the rod 32 of required length to the eyelet 22. In one preferred embodiment the closed length of the device 10 is approximately 27 mm measured from the center of the eyelet 16 to the eyelet 22. When mouth is opened wide the maximum length of the device 10 is in the range of 44-46 mm. This maximum length is almost equal to most of the maximum mouth opening in the teenage group of the general population. The present invention is designed in such a way, as to fit large sector of the population. In other words one size fits all, which makes the selection of the device less time consuming.

The length of the orthodontic bite jumping device 10 may be easily adjusted to different length by replacing the rod 32 with the rod of desired length and attaching it to the eyelet 22. For example if an orthodontic patient has been fitted with the orthodontic device having the rod length of 25 mm and during the course of treatment it is required that the length of the device has to be reduced then the technician need not have to cut the rod and it can replace the rod of length 26 mm with another rod (say 20 mm). In another example if an orthodontic patient has been fitted with the orthodontic device having the rod length of 25 mm and during the course of treatment it is required that the length of the device has to be increased then the technician can replace the rod of length 26 mm with another rod (say 28 mm). This saves time and effort needed to make the change in length of the orthodontic device. Also the rod may be made of such material which is corrosion free and scratch free such that the rod may be used after proper cleaning and disinfecting for another patient.

The rod 32 may be manufactured as a single part. In another embodiment of the present invention the rod 32 is manufactured as a plurality of parts. The plurality of parts may be two or more small rods joined together to form the rod 32.

The rod 32 may be attached to the eyelet 22 using any mechanism like partial welding, ball socket joint, threading mechanism or any removable connecting mechanism. In one embodiment of the present invention as shown in FIG. 2, the rod 32 is attached to the eyelet 22 by a thread mechanism. The rod 32 is provided with threads 34 at the end from which it is attached to the eyelet 22 and the eyelet 22 is provided with counter threads 36 to receive the rod 32. The threads 34 on the rod 32 are on its outer periphery forming external threads and the threads 36 of the eyelet 22 are internal threads such that the rod 32 and eyelet 22 are attached in male female part fashion.

In another embodiment of the present invention the threads 34 on the rod 32 may be made internal thread and the threads 36 on the eyelet 22 are external threads. The threads 34 on the rod and threads 36 on the eyelet may also be a combination of internal and external threads on the rod or the eyelet.

The plunger stop 24 comprises an enlarged end portion having a diameter more than the diameter of the plunger member 20 and the tube stop 18 comprises an end recess portion having a diameter less than the inner diameter of the tubular member 14, such that the end recess portion of the tubular member receives the enlarged end portion of the plunger member and prevents disengagement. The plunger member 20 does not disengage from the tubular member 14 even when the patient's mouth is opened to a maximum position.

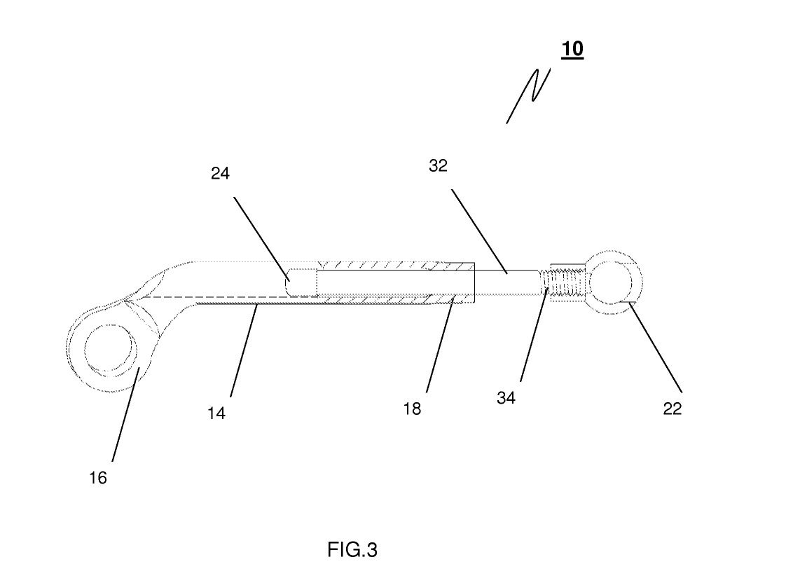

Referring to FIG. 3 which illustrates the tubular member 14 and the plunger member 20 assembled in one operating position, according to one embodiment of the present invention.

In majority of the cases, one standard fixed length will position the lower jaw in normal relationship. If required to shift lower jaw more forward, it can be easily accomplished with an open spacer in different length by adding on the rod at the lower end. The present embodiment of the orthodontic bite jumping device is rigid, but it can be easily converted into a semi rigid form by adding spring on the rod, if required during the treatment. In this fashion it is a very versatile invention to treat different kind of malocclusion.

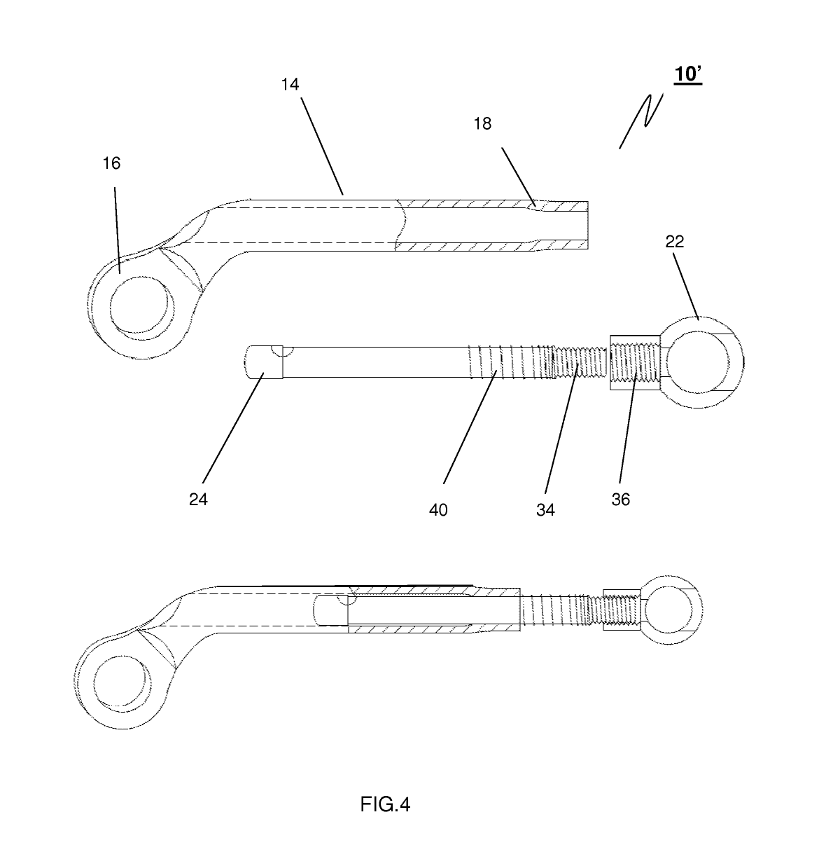

FIG. 4 illustrates the orthodontic bite jumping device 10′ with spring 40, according to another embodiment of the present invention. The orthodontic device 10 of the present invention may be converted into an active device with the open spring 40 when needed. Active device is needed in patients when there is negligible over jet and over bite, to generate the force to reposition lower jaw. The orthodontic bite jumping device 10′ comprising the spring 40 provides a resilient force between the two ends of the orthodontic bite jumping device 10′.

In one embodiment the spring 40 is located coaxial within the tubular member 14 extending externally around the plunger member 20 for providing the resilient force. In another embodiment the spring 40 is located coaxial outside the tubular member 14 and extending externally around the plunger member 20.

In yet another embodiment the spring 40 is located coaxial and extending externally around both the tubular member 14 and the plunger member 20.

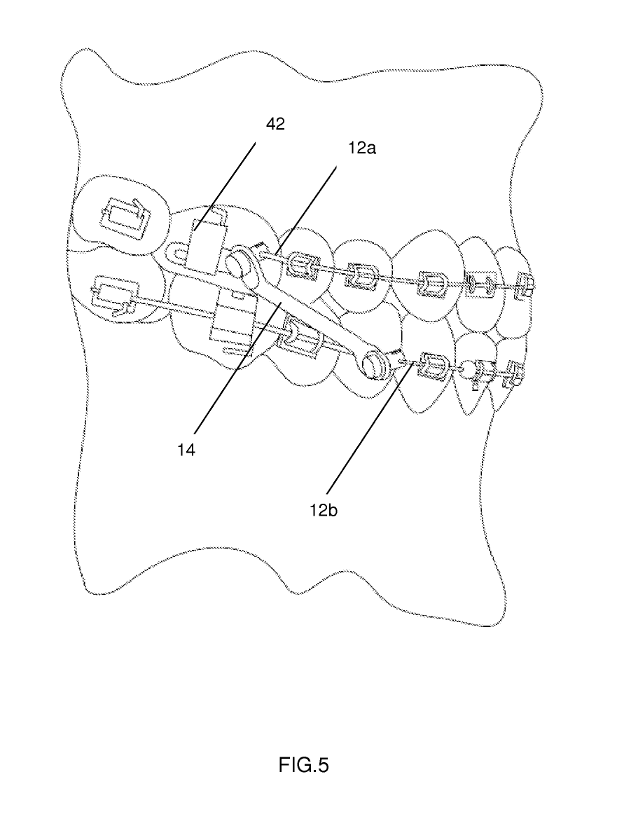

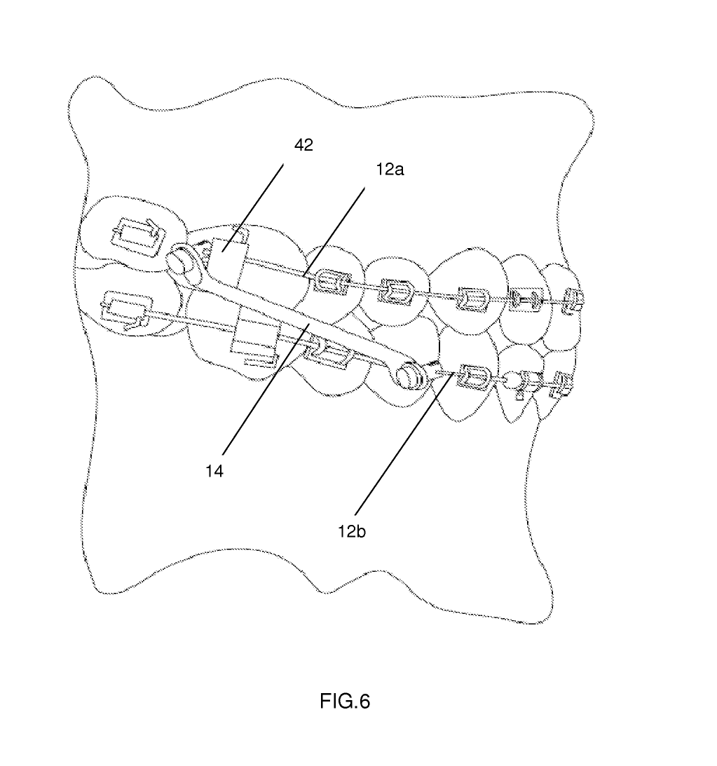

In the embodiment shown in FIG. 1 the orthodontic bite jumping device 10 is connected such that the first brace wire 12a and the second brace wire 12b are respectively connected to a maxilla and a mandibula of the patient. The tubular member 14 is directly connected to the first brace wire 12a. In two other embodiments as shown in FIGS. 5 and 6 which illustrates the side view of the orthodontic bite jumping device 10 installed in the head gear tube 42 from the mesial end and distal end respectively. In both embodiments the lower end of the orthodontic bite jumping device 10 with eyelet 24 is attached with pivot on the lower arch wire 12b but the upper end with eyelet 16 along with pivot or hinge 3 is attached in the upper head gear tube 42 at the mesial end in FIG. 5 or distal end FIG. 6. The line of force is more close to the center of the resistance in FIG. 5 causing more bodily movement of the upper molar with less tipping as compared to the distal installation.

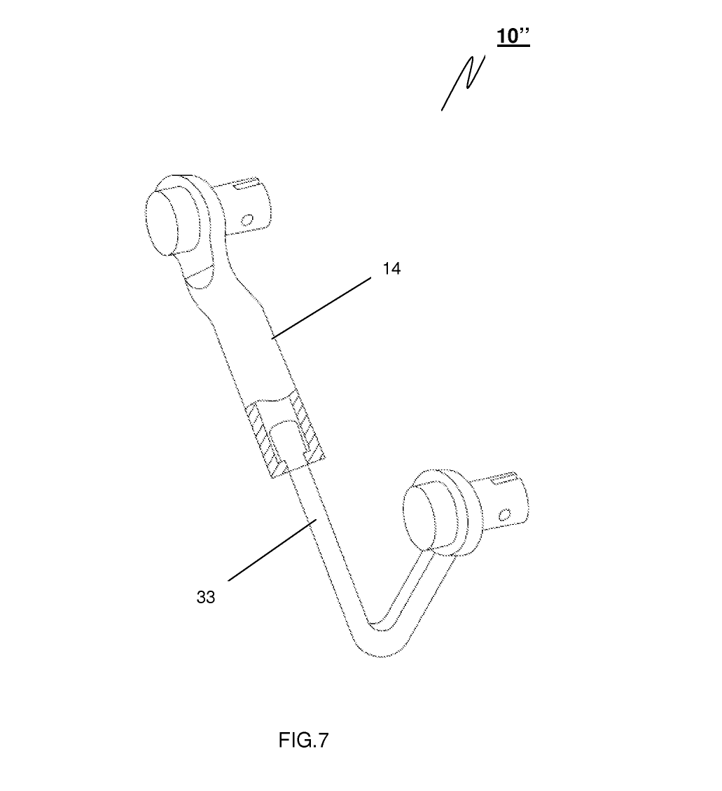

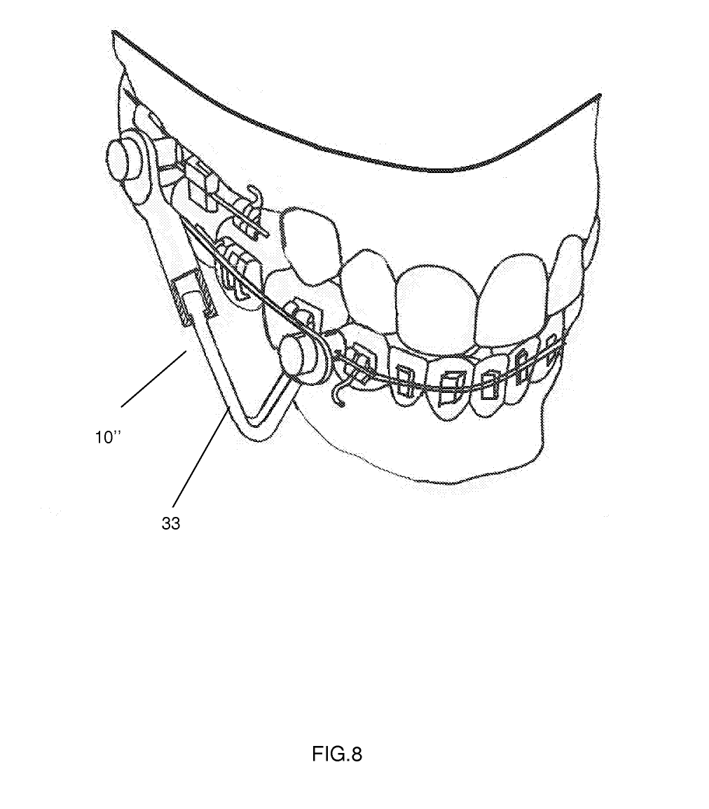

Referring to FIG. 7 which illustrates the perspective partial cross sectional view of the orthodontic bite jumping device 10″ with bent rod 33 at 90 degrees, according to another embodiment of the present invention and FIG. 8 which shows side view of the orthodontic bite jumping device 10″ as shown in the embodiment of FIG. 7, installed in a patient's mouth. The rod 33 is bent at 90 degree to create distal force at the lower end. This embodiment reduces the forward dumping of the lower anterior teeth. Forward dumping of the lower anterior teeth has been the main reason orthodontic society has been reluctant to advocate Herbst therapeutically application in their practice. As the patient closes mouth the forward force at the lower end of the bent rod 33 creates a distal force at the attached end of the pivot on the brace wire 12b.

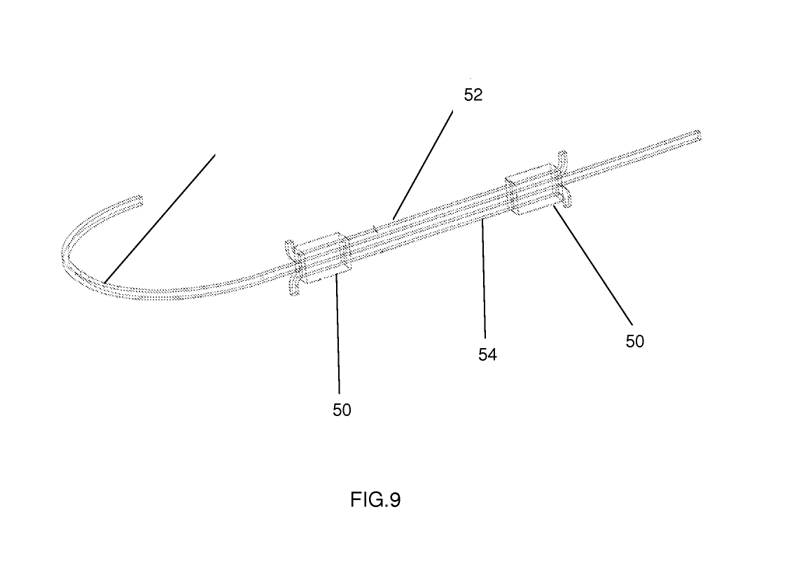

Referring to FIG. 9 which illustrates a schematic diagram of a method of reinforcement of the lower arch using a plurality of wires. Breakage in the lower arch has been the main reason orthodontists avoid integration of the Herbst appliance in their routine orthodontic practice. The lower arch wire 12b is being reinforced by means two triple tubes 50, where the main arch wire 12b in the middle is being reinforced with sectional arch wires 52 and 54 at the top and bottom respectively. The three wires combinely provide more strength to the orthodontic bite jumping device and avoid the breaking of the lower arch wire 12b due to masticatory forces.

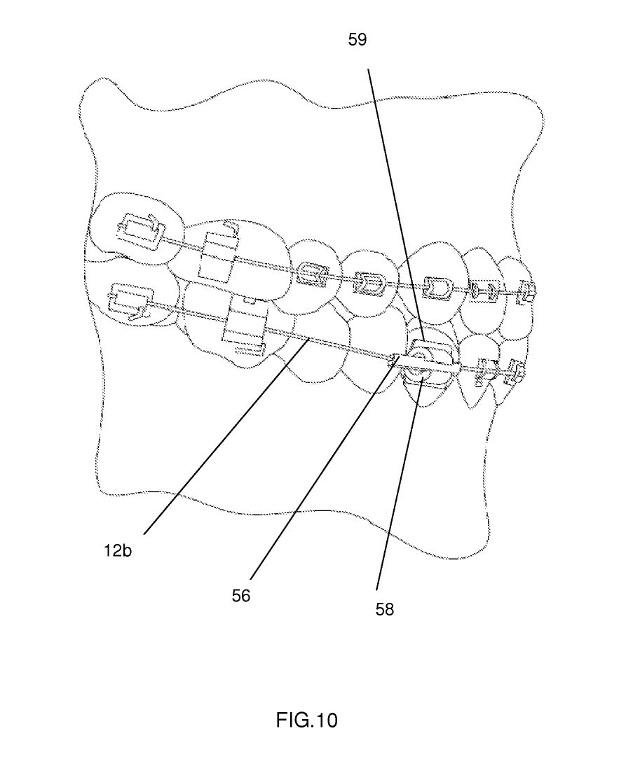

In another embodiment FIG. 10 illustrates a schematic diagram of a method of reinforcement of the lower arch 12b using a tube 56 and a large size bonding base with a open tube 58. The lower arch 12b is being reinforced with a rectangular or round tube 56 in the lower jaw. To tie such oversize arch wire 12b having the tube 56 in the cuspid region a modification of the lower cuspid bonding pad 59 is needed. A large size bonding pad with brazed open tube 58 is prefabricated to receive reinforced lower arch wire 12b.

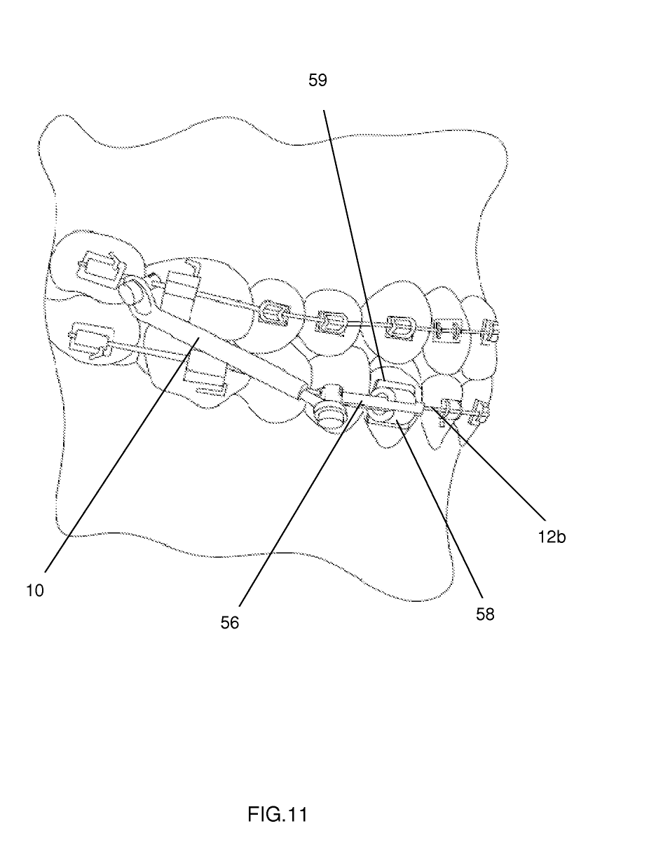

FIG. 11 illustrates the orthodontic bite jumping device 10 according to the present invention installed on the reinforcement of the lower arch as shown in FIG. 10 in a patient's mouth.

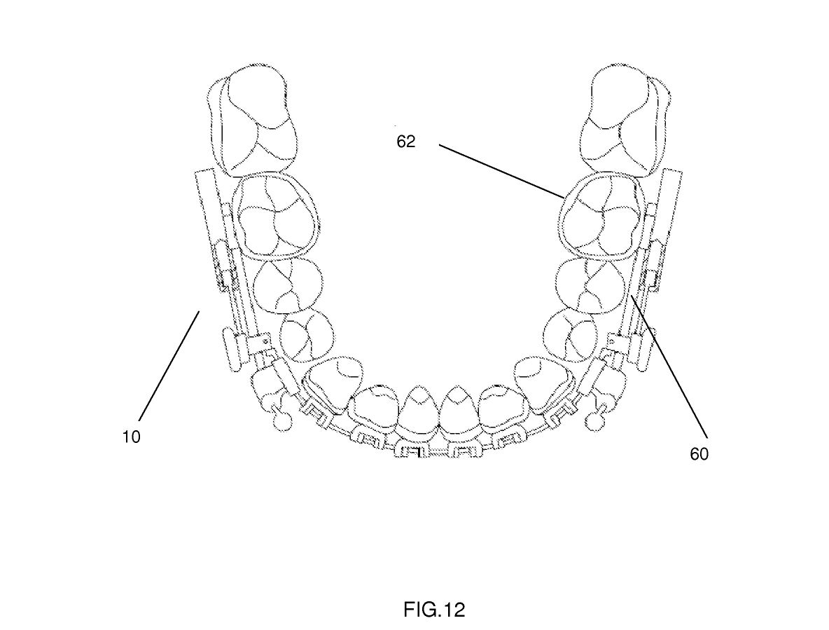

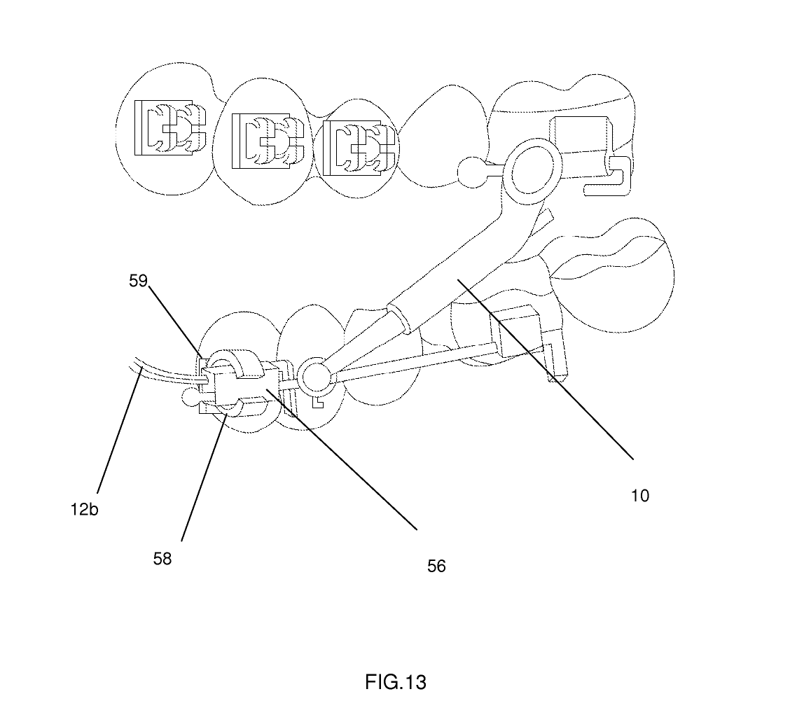

FIGS. 12 and 13 illustrates a occlusal view and a posterior view of the lower arch 12b of a patient's mouth with the orthodontic bite jumping device 10 according to the present invention installed on the posterior sectional arches respectively. As shown in the occlusal view the lower arch is divided into anterior section and posterior section. Lower section extends from cuspid to cuspid with a combination of round and edgewise tubes installed at the distal end of sectional arch partially extending in the interproximal area between cuspid and bicuspid. Combination tube is tied to the open tube 58 bonded to the lower cuspid tooth. Orthodontic bite jumping device 10 is installed on posterior section wire 60 which extend from the tube welded or bonded to the lower 1^{st} molar band 62. Sectional arch wire may be a round, edgewise or of any other shape or diameter to bear heavy masticatory forces during chewing and swallowing.

As can be appreciated, most of the figures from FIGS. 1 to 13 show only the left side portions of the maxillary and mandibular components but it is to be understood that a like structure would be presented at the right side of the mouth as shown in FIG. 12. Further, while only one orthodontic bite jumping device 10 is shown, it is to be understood that the appliance includes a pair of devices 10, each adapted to be positioned at each side of the mouth.

The orthodontic bite jumping device 10 is manufactured by stainless steel, but it may be manufactured in other material such as, plastic, ceramics or suitable material known to the person skilled in this art. The orthodontic bite jumping device 10 may be coated with Teflon (PTFE) to reduce friction for sliding movements of the parts.

In various exemplary embodiments of the present invention, the device discussed herein, e.g., with reference to FIGS. 1 to 13, may be supplemented with operations implemented through computing devices such as hardware, software, firmware, or combinations thereof, which may be provided as a computer program product, e.g., including a machine-readable or computer-readable medium having stored thereon instructions or software procedures used to program a computer to perform a process discussed herein. The machine-readable medium may include a storage device. For example, the operation of components of the system 10 and method 100 may be controlled by such machine-readable medium. Also automated masks such as LCD screens may be used.

In other instances, well-known devices, methods, procedures, components, and circuits have not been described herein so as not to obscure the particular embodiments of the present invention. Further, various aspects of embodiments of the present invention may be performed using various means, such as integrated semiconductor circuits, computer-readable instructions organized into one or more programs, or some combination of hardware and software.

Although a particular exemplary embodiment of the invention has been disclosed in detail for illustrative purposes, it will be recognized to those skilled in the art that variations or modifications of the disclosed invention, including the rearrangement in the configurations of the parts, changes in sizes and dimensions, variances in terms of shape may be possible. Accordingly, the invention is intended to embrace all such alternatives, modifications and variations as may fall within the spirit and scope of the present invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

What is claimed is:

1. An orthodontic bite jumping device attached to a pair of orthodontic brace wires affixed to a patient's teeth for correcting a relative position of dental arches, comprising:
at least one tubular member having an eyelet at one end for connection to a first brace wire and a tube stop at another end; and
at least one plunger member slidably and concentrically disposed in the tubular member; the plunger member having an eyelet at one end for connection to a second brace wire and a plunger stop, such that the plunger stop when coupled with the tube stop is adapted to prevent disengagement of the plunger member from the tubular member when mouth of the patient is opened to a maximum position.

2. The orthodontic bite jumping device according to claim 1, wherein the plunger member comprises at least one rod removably attached to the eyelet, such that a desired length of the orthodontic bite jumping device is obtained by attaching the rod of required length to the eyelet.

3. The orthodontic bite jumping device according to claim 2, wherein the rod is removably attached to the eyelet by a thread mechanism.

4. The orthodontic bite jumping device according to claim 2, wherein the rod is bent at an angle with the axis of the rod.

5. The orthodontic bite jumping device according to claim 2, wherein the rod is bent at an angle of 90 degrees with the axis of the rod.

6. The orthodontic bite jumping device according to claim 2, wherein the rod is manufactured as a single part.

7. The orthodontic bite jumping device according to claim 2, wherein the rod is manufactured as a plurality of parts.

8. The orthodontic bite jumping device according to claim 1, wherein the plunger stop comprises an enlarged end portion having a diameter more than the diameter of the plunger member and the tube stop comprises an end recess portion having a diameter less than the inner diameter of the tubular member, such that the end recess portion of the tubular member receives the enlarged end portion of the plunger member and prevents disengagement.

9. The orthodontic bite jumping device according to claim 1, wherein the first brace wire and the second brace wire are respectively connected to a maxilla and a mandibula of the patient.

10. The orthodontic bite jumping device according to claim 1, wherein the first brace wire and the second brace wire are respectively connected to a mandibula and a maxilla of the patient.

11. The orthodontic bite jumping device according to claim 9, wherein the tubular member is directly connected to the first brace wire.

12. The orthodontic bite jumping device according to claim 9, wherein the tubular member is connected to a head gear tube located on the first brace wire.

13. The orthodontic bite jumping device according to claim 12, wherein the tubular member is connected to an anterior end of the head gear tube.

14. The orthodontic bite jumping device according to claim 12, wherein the tubular member is connected to a posterior end of the head gear tube.

15. The orthodontic bite jumping device according to claim 1, wherein the plunger member is freely slidable relative to the tubular member.

16. The orthodontic bite jumping device according to claim 1, wherein the device further comprises at least one spring for providing a resilient force between the two ends of the orthodontic bite jumping device.

17. The orthodontic bite jumping device according to claim 16, wherein the at least one spring is located coaxial within the tubular member extending externally around the plunger member for providing the resilient force.

18. The orthodontic bite jumping device according to claim 16, wherein the at least one spring is located coaxial outside the tubular member extending externally around the plunger member.

19. The orthodontic bite jumping device according to claim 16, wherein the at least one spring is located coaxial and extending externally around both the tubular member and the plunger member.

20. The orthodontic bite jumping device according to claim 1, wherein the eyelet of the tubular member is angularly offset from the longitudinal axis of the tubular member.

21. The orthodontic device according to claim 20, wherein the eyelet of the tubular member is angularly offset by 45 degrees towards the teeth.

22. The orthodontic bite jumping device according to claim 1, wherein the tubular member is manufactured as a single part.

23. The orthodontic bite jumping device according to claim 1, wherein the tubular member is manufactured as a plurality of parts.

24. The orthodontic bite jumping device according to claim 1, wherein the tubular member and the plunger member are attached to the pair of brace wires from the respective eyelets using at least one mechanism from a list including a pivot, a screwed pivot, a soldered pivot or a combination thereof.
